(19) United States
(12) Patent Application Publication
(10) Pub. No.: US 2015/0113449 A1
(43) Pub. Date: Apr. 23, 2015

(54) SYSTEM AND METHOD FOR PROVIDING USER INTERFACE

(71) Applicant: Korea Electronics Technology Institute, Seongnam-si (KR)

(72) Inventors: Jae Won MOON, Seoul (KR); Jong Jin JUNG, Seoul (KR); Tae Beom LIM, Yongin-si (KR); Kyung Won KIM, Seoul (KR); Seung Woo KUM, Yongin-si (KR); Jong Bin PARK, Hwaseong-si (KR)

(73) Assignee: Korea Electronics Technology Institute, Seongnam-si (KR)

(21) Appl. No.: 14/226,187

(22) Filed: Mar. 26, 2014

(30) Foreign Application Priority Data
Oct. 23, 2013 (KR) 10-2013-0126574

(51) Int. Cl. G06F 3/0484

(52) U.S. Cl. CPC G06F 3/0484
USPC 715/762

(57) ABSTRACT

If a content creator that creates content and a service provider that provides the content are different, the content should be reconfigured and provided. In order to provide an interface suitable for a user environment, only a limited user environment should be considered. Thus, flexibility is low when an adaptive user interface is provided. It is possible to provide a user interface, independently of the relevant designer, by redefining content, a usage environment, and a relation between a page and a service provider and dynamically providing a user interface suitable for the user environment.

### CROSS-REFERENCE TO RELATED APPLICATIONS

This application claims priority under 35 U.S.C. §119 to Korean Patent Application No. 10-2013-0126574, filed on Oct. 23, 2013, the disclosure of which is incorporated herein by reference in its entirety.

### TECHNICAL FIELD

The present invention relates to a system and method for creating and providing a user interface, and more particularly, to a system and method for providing a user interface independently of a content provider to provide a user interface suitable for a usage environment of a user.

### BACKGROUND

Highly-developed intellectual technology (IT) devices and networks allow a variety of multimedia content to be shared between and used in cooperation with heterogeneous devices. Examples of such heterogeneous devices include a personal computer (PC), a television (TV), a personal digital assistant (PDA), and a mobile phone, which are required to have a communication standard specification and an improved user convenience and provide a resource sharing/cooperation function and an application service in order to perform smooth sharing with other devices.

To overcome these issues, methods of adaptively providing content using a multiplexing video coding such as a scalable video coding have been mainly discussed, but they are just encoding techniques optimized for video. Accordingly, since presentation information including video is provided in real services, all elements associated with this should be considered.

With increase in devices for providing information such as an advertisement utilizing digital media content, much research has been conducted on how to provide scalable information depending on the context. Users focus on viewing of scalable images while providers focus on convenient manipulation in order to quickly provide a variety of information.

In the related art, user interface technologies are technologies for performing branching to different pages or servers depending on the usage environment to provide different user environments. Alternatively, the related art user interface technologies configure a dynamic user page to allow servers to reproduce the user page depending on the context. In this case, since user pages are configured in advance to a certain degree and delivered in most technologies, user environments, which are the change parameters, are limited to a certain range.

However, if a creator that creates content is different from a service provider that provides the content, the content should be previously defined and then used, in order to prevent difficulties in recycling, management, and so on of the content.

Thus existing relevant patents (Method for providing customized advertisement/news on scalable application service system, Authoring apparatus for scalable application service and authoring method using the authoring apparatus, Parsing apparatus for scalable application service and parsing method using the parsing apparatus, Collaborative service system using mobile device and method for providing collaborative service using mobile device in home server of the system, Digital apparatus on which a scalable application authoring tool is installed, and so on) have proposed apparatuses and methods for providing application programs optimized for each terminal in a network environment constituting a variety of terminals in consideration of the above-described environment.

The existing patents propose methods for supplying scalable content to clients on systems, which have limitations with respect to high dependency between resources of a framework and thus difficulties in recycling resources and applying another application.

### SUMMARY

Accordingly, the present invention provides a system and method for providing a user interface that is designed to minimize the dependency between a resource and a final user interface to allow the resource to be freely recycled or reapplied depending on characteristics of application programs.

In one general aspect, a method of providing a user interface includes: receiving user request information; configuring a page to be displayed on a screen and an item included in the page, based on the user request information; checking whether a component connected to the item is valid; if the component is valid, providing content corresponding to a resource connected with the component; and receiving feedback information from a user and changing a configuration of the page and the item based on the feedback information.

The checking of whether a component connected to the item is valid may include comparing condition information about the component with the user request information and if the condition information is consistent with the user request information, determining that the component is valid.

The providing of content may include providing the content on a screen including the page and the item.

The receiving of user request information may include receiving information about a device for displaying the page.

In another general aspect, a system for providing a user interface includes: a component configured to include resource information and condition information; an item configured to check whether the condition information of the component is valid and if the condition information is valid, display the component; and a page configured to provide a screen including one or more items.

### BRIEF DESCRIPTION OF THE DRAWINGS

FIGS. 1 to 6 are views illustrating elements of a system for providing a user interface according to an embodiment of the present invention.

FIGS. 7 and 8 are views illustrating a flow of a user interface with a system for providing a user interface according to an embodiment of the present invention.

FIGS. 9 and 10 are views illustrating an embodiment in which a system for providing a user interface provides a user interface according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Hereinafter, embodiments of the present invention will be described in detail with reference to the accompanying drawings.

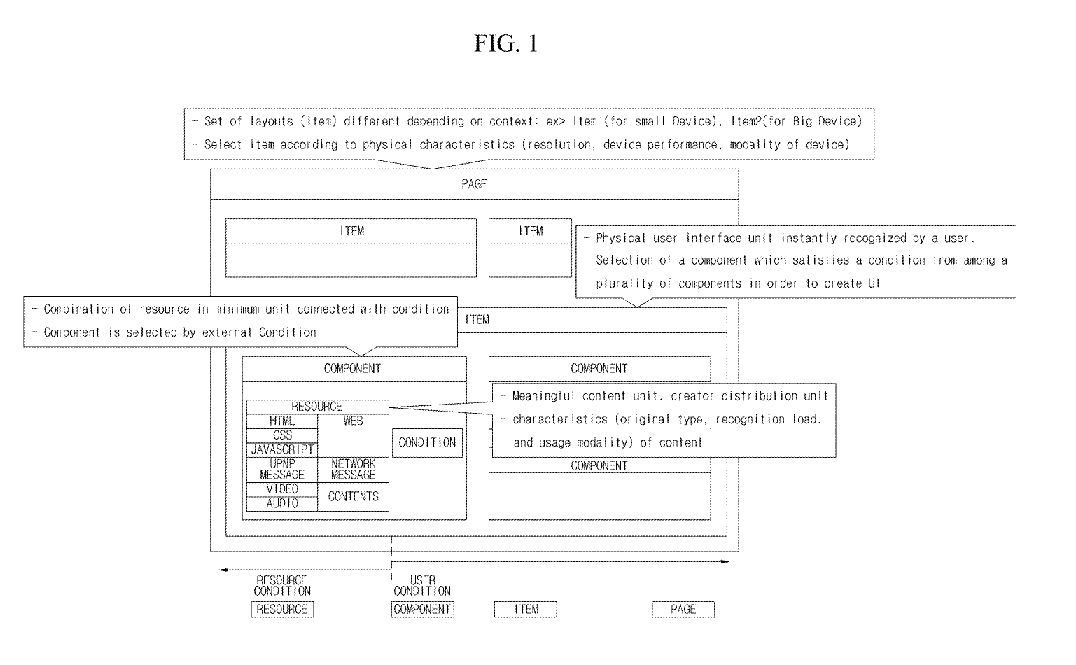

FIGS. 1 to 6 are views illustrating elements of a system for providing a user interface according to an embodiment of the present invention.

FIG. 1 is a view illustrating a relation among a page, an item, a component, a condition, and a resource, which are elements that are used in a method of providing a user interface according to an embodiment of the present invention.

As shown in FIG. 1, the present invention includes selecting, by a specific page, an item appropriate for a size and characteristics of a physical device upon a user's request; selecting, by an item, a component including the item to call and inquire about a value according to DCFunctionName; performing determination on an valid component; selecting a lower resource; extracting a resource for the component; and providing a final user interface.

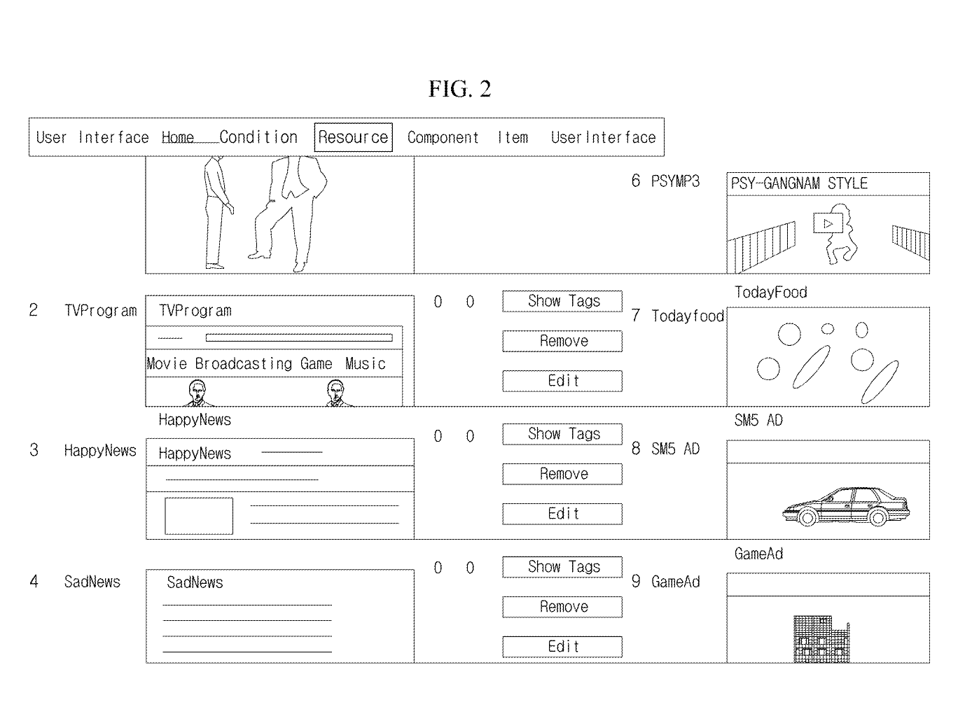

FIGS. 2 to 6 are views illustrating concepts of a page, an item, a component, a condition, and a resource. Elements used to configure a user interface adaptive to a user environment in an organizer are defined as follows.

FIG. 2 is a view illustrating a resource and represents drawings, each of which indicates one resource unit.

The resource is a description about a state of content and is a minimum unit, a meaningful unit of content, and also a unit of distribution of creators. The resource may describe its characteristics such as an original type, a recognition load, and a usage modality of content.

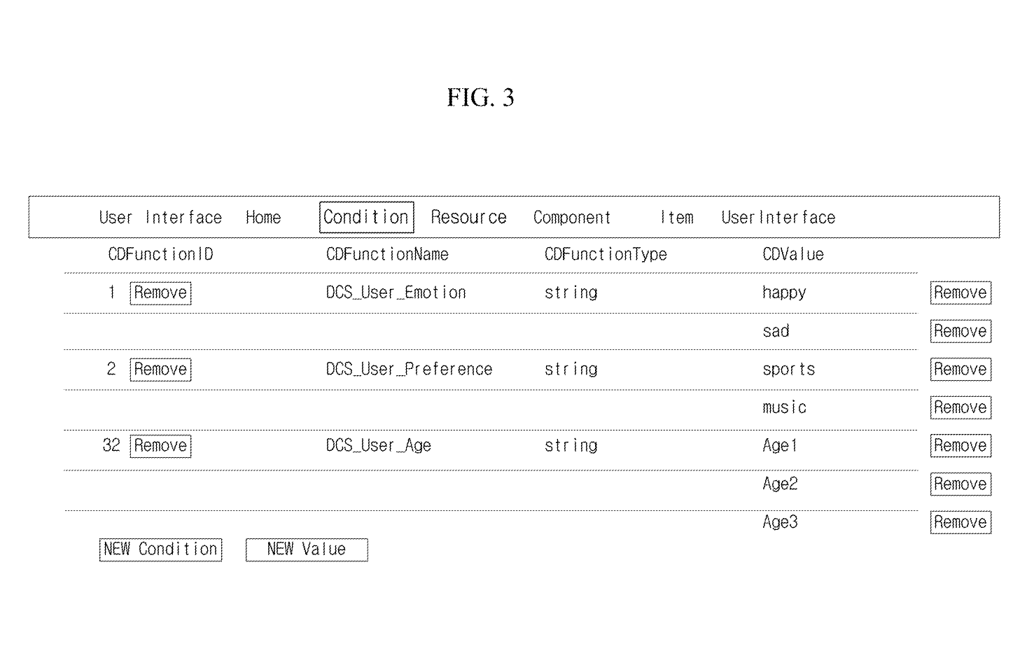

FIG. 3 is a view illustrating a condition.

The condition is a description about a use state of a user, and is used in a component to validate only a component corresponding to context information about a user. The condition is a unit associated with a usage environment of the user and may be changed by a service provider according to the usage environment and then newly registered.

For example, as shown in FIG. 3, a column value of the condition includes CDFUnctionID, CDFunctionName (a current context information value, such as DCS_User_Emotion and DCS_User_Preference, which may be interpreted by a system), CDFunctionType, CDValue (a value taken when a value of CDFunctionName is inquired), and so on. Details of the condition should be defined before each connection relation is defined in order to provide a user interface. Each column value may be changed according to the service context.

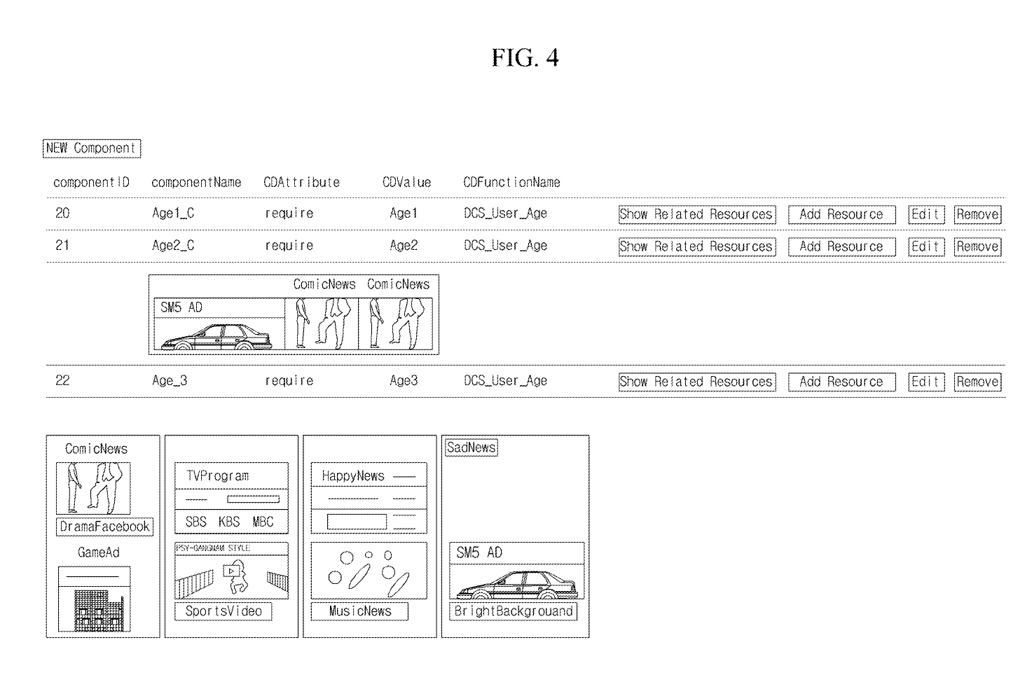

FIG. 4 is a view illustrating a component.

The component is a unit selected for the user context information, and has the condition and the resource. The component may have one or more resources and omit a condition of a component that is valid irrespective of the conditions.

The component is closely connected with a usage environment of a user. According to this mechanism, the final user interface is allowed to be changed. For example, component “A” is selected depending on a condition value, and thus only when DCS_User_Emotion user environment variable is “happy”, component “A” is selected as being true.

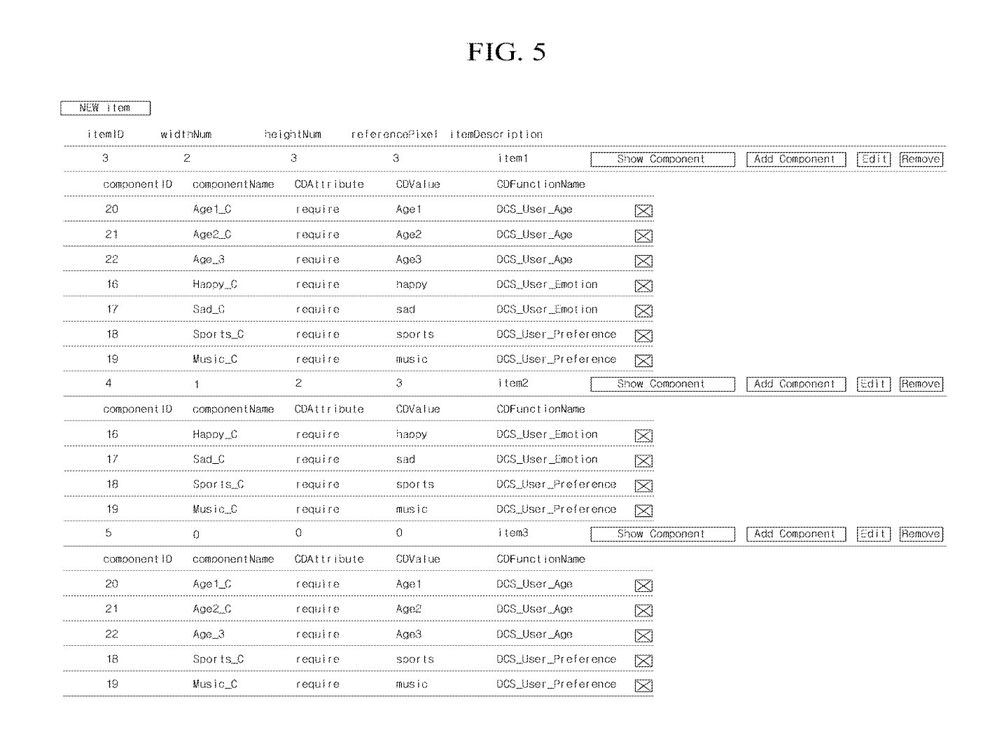

FIG. 5 is a view illustrating a concept of an item.

The item is an independent unit of a physical user interface that is recognized by a user, and selects a component suitable for a condition from among several components to create a user interface. The item determines a component that is finally selected using a unit width, a unit length, and component index information. Basically, the item includes several components. However, since all of the components are not true, resources of the finally selected components constitute the user interface.

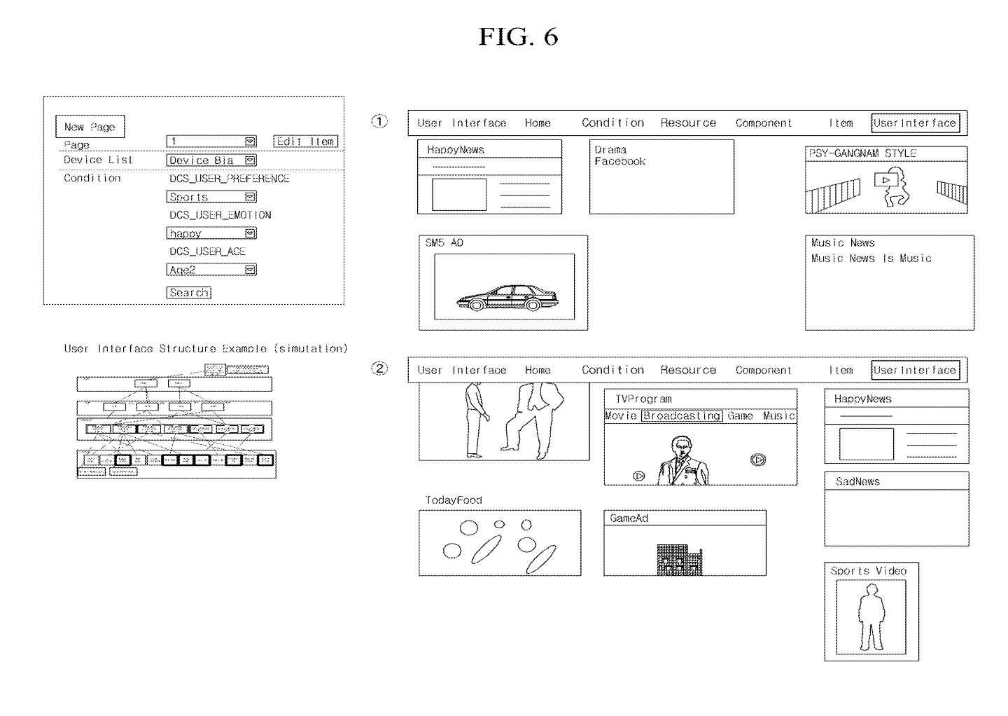

FIG. 6 is a view illustrating a concept of a page and a process of setting the page.

The page is an abstract step of the user interface and an upper layer of an actual item. Depending on which device is used by a user in a layout different depending on the context, physical characteristics (resolution, device performance, and modality) are different between devices, and a page has one or more items in order to adaptively show the physical characteristics.

FIG. 6 illustrates a case in which Page 1 is selected from among Page 1 and Page 2, and illustrates a result of selection of a Device Big Item and selecting conditions Sports, Happy, and Age2. Page 2 illustrates a user interface of when another environment is selected.

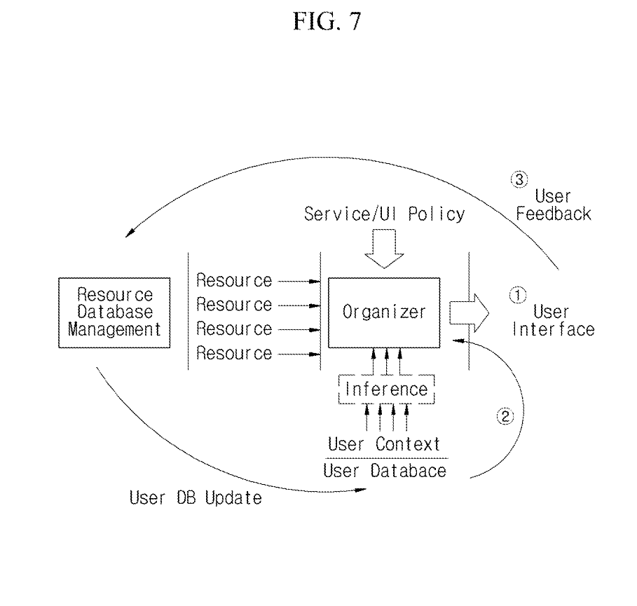

FIG. 7 illustrates a flow of a user interface in a system for providing a user interface according to an embodiment of the present invention.

Several resources are packaged as a component, an item, and so on and delivered, and an organizer picks up an appropriate resource according to a table in which connection relations are described. In this case, a user receives several user contexts, and the user contexts correspond to values of CDFunctionName of the condition. Depending on the user context, the organizer may provide a user-adaptive interface or provide an interface reconfigured based on the user feedback.

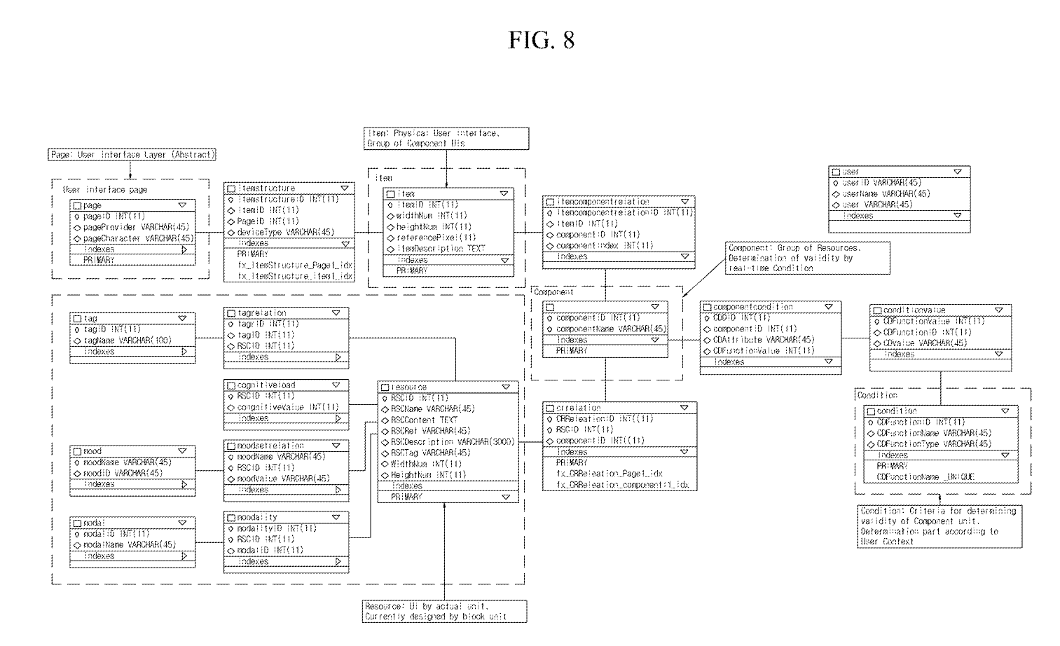

FIG. 8 specifically illustrates a relation between elements of a system for providing a user interface according to an embodiment of the present invention.

The resource, component, condition, item, and page, which are the elements, are configured and connected as shown in FIG. 8. Each component can be used and connected, independently of its characteristics, when CRRelation (Data for describing a relation between Component and Resource), ComponentCondition (Data for describing a Condition of each Component), ItemComponentRelation (Data for describing a relation between Item and Component), ItemStructure (Data for describing a relation between Page and Item) are set depending on the context.

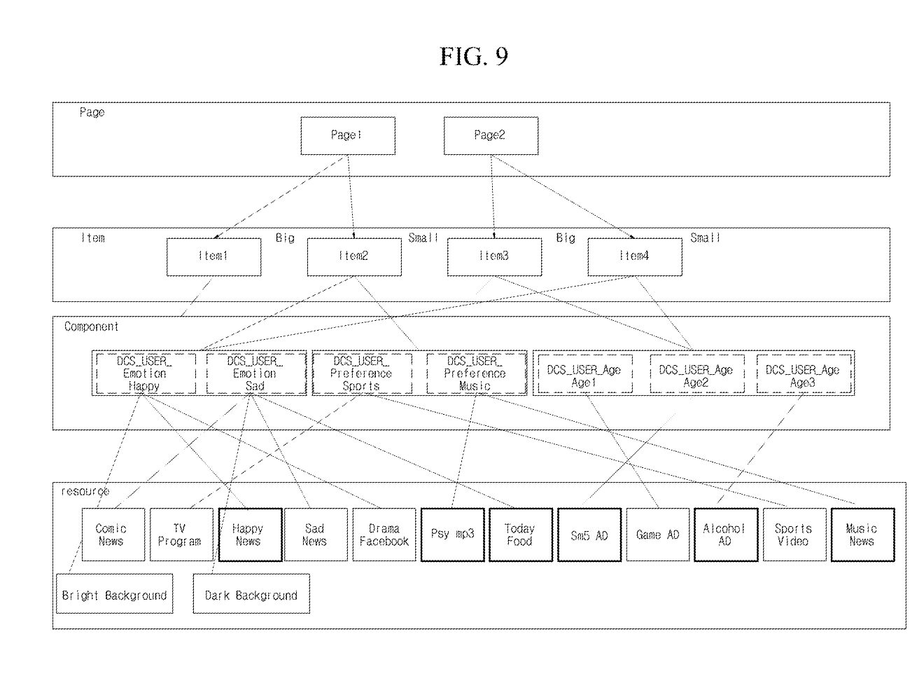

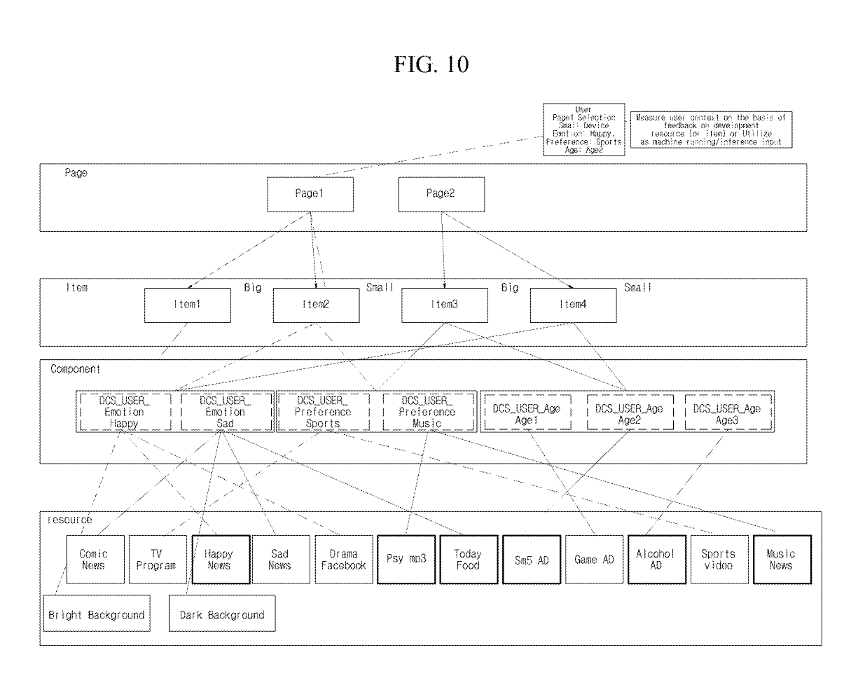

FIGS. 9 and 10 are views illustrating a process of providing a user interface by a system for providing a user interface according to an embodiment of the present invention.

When there are resources such as comic news, TV programs, Happy News, and so on, each component selects a necessary resource. Information on the selected resource is described in a CRRelation table. Each component is selected according to a policy of a service provider about information associated with a user environment. The associated information will be described in a ComponentCondition table. Each item selects necessary components (on the basis of ItemComponentRelation) and connects the components to an actual user interface screen. When the screen itself is shown differently depending on the physical context, a page is selected, and the item is connected according to the physical context.

Accordingly, the present invention describes elements and tables of relations between the elements, independently of each other, and thus allows a user interface to be provided, independently of a content creator, a service provider, and a service policy.

That is, the content creator separately records information on content, the service provider defines the information on content and a usage environment and also defines which content is shown, and thus the user receives a user interface depending on the usage environment.

According to the present invention, it is possible to facilitate reuse, recycling, and implementation into another application. The present invention also facilitates modification and change using a parameter table in order to preserve independence between elements while the existing patent is configured with the setting of static usage environment of an XML base. The present invention also has high flexibility, compared to the existing patent, to provide a user interface adaptive to a user's usage environment in which a service provider has a high degree of freedom with respect to the user environment setting.

The present invention relates to a method of setting, reconfiguring, and distributing each resource separately, depending on the context, in order to adaptively provide a user interface, in which the resource is sequentially set as a component, an item, and then a page, and the final user interface analyzes a context of a usage environment of a user to provide a user environment suitable for the analyzed context.

The present invention also relates to a method of dynamically reconfiguring an interface optimized for the usage environment of the user that is provided with the final user interface when a creator that creates content is different from a service provider that provides the content. It is possible to flexibly provide an adaptive user interface since each configuration level is independent even when any content creator or service provider is joined or the usage environment of the user is changed.

The above-described subject matter of the present invention is to be considered illustrative and not restrictive, and it should be understood that numerous other modifications and embodiments can be devised by those skilled in the art that will fall within the spirit and scope of the principles of the present invention. Accordingly, the embodiments of the present invention are to be considered descriptive and not restrictive of the present invention, and do not limit the scope of the present invention. The scope of the present invention should be determined by the following claims and their appropriate legal equivalents.

What is claimed is:

1. A method of providing a user interface, the method comprising:
receiving user request information;
configuring a page to be displayed on a screen and an item included in the page, based on the user request information;
checking whether a component connected to the item is valid; and
if the component is valid, providing content corresponding to a resource connected with the component.

2. The method of claim 1, wherein the checking of whether a component connected to the item is valid comprises comparing condition information about the component with the user request information and if the condition information is consistent with the user request information, determining that the component is valid.

3. The method of claim 1, wherein the providing of content comprises providing the content on a screen including the page and the item.

4. The method of claim 1, wherein the receiving of user request information comprises receiving information about a device for displaying the page.

5. The method of claim 1, further comprising receiving feedback information from a user and changing a configuration of the page and the item based on the feedback information.

6. A system for providing a user interface, the system comprising:
a component configured to include resource information and condition information;
an item configured to check whether the condition information of the component is valid and display the component having the valid condition information; and
a page configured to provide a screen including one or more items.

7. The system of claim 6, wherein the item compares the condition information of the component with the user request information to check whether the condition information is valid.

8. The system of claim 6, wherein the item checks a component connected with the item based on data for configuring a relation with the component.

9. The system of claim 6, wherein the page selects an item to be displayed on the page and configures the screen based on data for configuring a relation with the item.

10. The system of claim 6, wherein the component displays content corresponding to the resource information based on the resource information.
